(19) United States
(12) Patent Application Publication
(10) Pub. No.: US 2020/0234664 A1
(43) Pub. Date: Jul. 23, 2020

(54) Array Substrate, Liquid Crystal Display Device and Driving Method Thereof

(71) Applicants: Hefei Xinsheng Optoelectronics Technology Co., Ltd., Hefei (CN); BOE Technology Group Co., Ltd., Beijing (CN)

(72) Inventor: Hui Li, Beijing (CN)

(73) Assignees: Hefei Xinsheng Optoelectronics Technology Co., Ltd., Hefei (CN); BOE Technology Group Co., Ltd., Beijing (CN)

(21) Appl. No.: 16/507,707

(22) Filed: Jul. 10, 2019

(30) Foreign Application Priority Data
Jan. 22, 2019 (CN) 201910060251.1

(51) Int. Cl. G09G 3/36; G02F 1/155; G02F 1/163; G02F 1/1335; G09G 3/38

(52) U.S. Cl. CPC G09G 3/3614; G02F 1/155; G02F 1/163; G09G 2320/0247; G09G 3/38; G02F 2201/44; G02F 1/1335

(57) ABSTRACT

An array substrate, a liquid crystal display device and a driving method thereof are disclosed. The array substrate includes a base substrate; and a first electrode, a second electrode and a light transmittance adjusting layer, which are on the base substrate. The first electrode and the second electrode are configured to form a driving electric field, which is between the first electrode and the second electrode and runs through the light transmittance adjusting layer, when the first electrode is applied with a first driving voltage and the second electrode is applied with a second driving voltage; and light transmittance of the light transmittance adjusting layer is configured to be adjusted at least partially according to a change in a direction of the driving electric field.

### CROSS REFERENCE TO RELATED APPLICATIONS

The present application claims priority of Chinese Patent Application No. 201910060251.1 filed on Jan. 22, 2019, the disclosure of which is incorporated herein by reference in its entirety as part of the present application.

### TECHNICAL FIELD

Embodiments of the present disclosure relate to an array substrate, a liquid crystal display (LCD) device and a driving method thereof.

### BACKGROUND

Liquid crystal display (LCD) device is favored by consumers because of its low power consumption and the LCD device is suitable for various electronic devices. The LCD device includes polarizers, an array substrate, an opposed substrate, and a liquid crystal layer filled between the two substrates. The LCD device allows the liquid crystal molecules in the liquid crystal layer to rotate by forming an electric field between the array substrate and the opposed substrate, and the rotated liquid crystal molecules are combined with the polarizers to form a liquid crystal light valve. Because the liquid crystal layer does not emit light, it is necessary to adopt a backlight module to realize the display function.

The pixel electrode and the common electrode in the LCD device are generally referred to as drive electrodes. Because the voltage of the common electrode generally remains unchanged, the polarity (positive or negative) of the voltage of the pixel electrode is obtained through comparing with the common electrode. When the voltage of the pixel electrode is higher than the voltage of the common electrode, the polarity of the voltage of the pixel electrode is positive polarity (a corresponding display image is an image in a positive frame); and when the voltage of the pixel electrode is lower than the voltage of the common electrode, the polarity of the voltage of the pixel electrode is negative polarity (a corresponding display image is an image in a negative frame). For example, in the case where the voltage of the common electrode is IV, if the voltage of the pixel electrode is 3V, the polarity of the voltage of the pixel electrode is positive polarity; and if the voltage of the pixel electrode is −1V, the polarity of the voltage of the pixel electrode is negative polarity.

In actual display processes, if the liquid crystal molecules continue to work under one of the polarities, the liquid crystal molecules can be damaged and cannot be restored. Therefore, it is necessary to invert the polarity of the voltage of the pixel electrode at intervals, that is, to exchange the positive polarity and the negative polarity of the voltage of the drive electrode. Because the rotation angle of the liquid crystal molecules and the grayscale of pixels are relevant to the magnitude of the liquid crystal driving electric field formed by the drive electrodes (substantially depending on the absolute value of the voltage difference between the pixel electrode and the common electrode), and the rotation angle of the liquid crystal molecules depends on the polarity of the drive electrodes, the polarity inversion cannot affect the grayscale displayed by the pixels. For example, in the case where the voltage of the common electrode is 1V, if the voltage of the pixel electrode is 3V, the polarity of the voltage of the pixel electrode is positive polarity; and if the voltage of the pixel electrode is −1V, the polarity of the voltage of the pixel electrode is negative polarity. For example, in the case where the voltage of the common electrode is IV, when the voltage of the pixel electrode is 3V, the rotation angle of the liquid crystals is the same as the case when the voltage of the pixel electrode is −1V, that is, the transmittance of a combination structure of the liquid crystal molecules and the polarizers is the same under the above two kinds of voltage of pixel electrode.

### SUMMARY

At least one embodiment of the present disclosure provides an array substrate, which comprises: a base substrate; and a first electrode, a second electrode and a light transmittance adjusting layer, which are on the base substrate. The first electrode and the second electrode are configured to form a driving electric field, which is between the first electrode and the second electrode and runs through the light transmittance adjusting layer, when the first electrode is applied with a first driving voltage and the second electrode is applied with a second driving voltage; and light transmittance of the light transmittance adjusting layer is configured to be adjusted at least partially according to a change in a direction of the driving electric field.

For example, in at least one example of the array substrate, the light transmittance adjusting layer comprises an electrochromic material; the light transmittance of the light transmittance adjusting layer is configured to change in accordance with color of the electrochromic material; and the color of the electrochromic material is configured to change in accordance with the change in the direction of the driving electric field.

For example, in at least one example of the array substrate, the light transmittance adjusting layer comprises an ion storage layer and an electrochromic material layer which are superimposed to and in contact with each other, and the electrochromic material layer comprises the electrochromic material; and the electrochromic material layer is configured to change color by exchanging ions with the ion storage layer according to the change in the direction of the driving electric field.

For example, in at least one example of the array substrate, the light transmittance adjusting layer comprises a base and a plurality of particles dispersed in the base; each of the plurality of particles comprises a first part formed by an ion storage material and a second part formed by the electrochromic material; and the second part is configured to change color by exchanging ions with the first part according to the direction of the driving electric field.

For example, in at least one example of the array substrate, the first electrode and the second electrode are respectively on different sides of the light transmittance adjusting layer relative to the base substrate.

For example, in at least one example of the array substrate, the first electrode and the second electrode are on a same side of the light transmittance adjusting layer relative to the base substrate.

For example, in at least one example of the array substrate, the first electrode and the second electrode are on a same side of the light transmittance adjusting layer relative to the base substrate, and the first electrode and the second electrode are in a same structural layer.

For example, in at least one example of the array substrate, the first electrode comprises a plurality of first sub-electrodes, and the second electrode comprises a plurality of second sub-electrodes; the plurality of first sub-electrodes and the plurality of second sub-electrodes respectively extend along a first direction; and the plurality of first sub-electrodes and the plurality of second sub-electrodes are alternately arranged in a second direction intersected with the first direction.

For example, in at least one example of the array substrate, the first electrode and the second electrode comprise a transparent conductive material.

For example, in at least one example of the array substrate, the first electrode is used as a pixel electrode, and the second electrode is used as a common electrode; and the first driving voltage is used as a pixel data voltage, and the second driving voltage is used as a common voltage.

For example, in at least one example of the array substrate, the array substrate further comprises a pixel electrode. The pixel electrode is on a side of a combination structure of the first electrode, the second electrode and the light transmittance adjusting layer away from the base substrate; and the pixel electrode is configured to be applied with a pixel data voltage.

At least one embodiment of the present disclosure further provides a liquid crystal display (LCD) device, which comprises an array substrate. The array substrate comprises a base substrate, and a first electrode, a second electrode and a light transmittance adjusting layer, which are on the base substrate; the first electrode and the second electrode are configured to form a driving electric field, which is between the first electrode and the second electrode and runs through the light transmittance adjusting layer, when the first electrode is applied with a first driving voltage and the second electrode is applied with a second driving voltage; and light transmittance of the light transmittance adjusting layer is configured to be adjusted at least partially according to a change in a direction of the driving electric field.

For example, in at least one example of the LCD device, the LCD device further comprises a drive circuit. The drive circuit is configured to apply the first driving voltage to the first electrode and apply the second driving voltage to the second electrode in adjacent display frames, so as to allow directions of driving electric fields in the adjacent display frames to be opposite.

For example, in at least one example of the LCD device, the first driving voltage, which is applied to the first electrode in the adjacent display frames, and the second driving voltage, which is applied to the second electrode in the adjacent display frames, allow absolute values of first voltage differences between the first electrode and the second electrode in the adjacent display frames to be equal, and allow signs of the first voltage differences in the adjacent display frames to be opposite.

At least one embodiment of the present disclosure further provides a method for driving an LCD device, which comprises: applying a first driving voltage to a first electrode of an array substrate of the LCD device and a second driving voltage to a second electrode of the array substrate of the LCD device in adjacent display frames, so as to allow directions of driving electric fields in the adjacent display frames to be opposite. The array substrate further comprises a base substrate and a light transmittance adjusting layer; the first electrode, the second electrode and the light transmittance adjusting layer are on the base substrate; the driving electric fields are formed when the first electrode is applied with the first driving voltage and the second electrode is applied with the second driving voltage; the driving electric fields are between the first electrode and the second electrode and run through the light transmittance adjusting layer; and light transmittance of the light transmittance adjusting layer is configured to be adjusted at least partially according to a change in directions of the driving electric fields.

For example, in at least one example of the method for driving the LCD device, the first driving voltage and the second driving voltage are applied respectively to the first electrode and the second electrode in the adjacent display frames; and signs of the first voltage differences between the first electrode and the second electrode in the adjacent display frames are opposite.

For example, in at least one example of the method for driving the LCD device, absolute values of the first voltage differences between the first electrode and the second electrode in the adjacent display frames are equal.

For example, in at least one example of the method for driving the LCD device, the LCD device further comprises a liquid crystal light adjusting structure; the liquid crystal light adjusting structure comprises a liquid crystal layer, a pixel electrode and a common electrode; the pixel electrode and the common electrode are respectively applied with a pixel data voltage and a common voltage to form a liquid crystal driving electric field for controlling rotation of liquid crystal molecules in the liquid crystal layer; and the driving method further comprises: respectively applying the pixel data voltage and the common voltage to the pixel electrode and the common electrode in the adjacent display frames, so as to allow directions of liquid crystal driving electric fields in the adjacent display frames to be opposite. Allowing of the directions of the liquid crystal driving electric fields in the adjacent display frames to be opposite comprises: allowing signs of second voltage differences between the pixel electrode and the common electrode to be opposite; and the first driving voltage and the second driving voltage are respectively used as the pixel data voltage and the common voltage.

For example, in at least one example of the method for driving the LCD device, the LCD device further comprises a liquid crystal light adjusting structure; the liquid crystal light adjusting structure comprises a liquid crystal layer, a pixel electrode and a common electrode; the pixel electrode and the common electrode are respectively applied with a pixel data voltage and a common voltage to form a liquid crystal driving electric field for controlling rotation of liquid crystal molecules in the liquid crystal layer; and the driving method further comprises: respectively applying the pixel data voltage and the common voltage to the pixel electrode and the common electrode in the adjacent display frames, so as to allow the directions of the liquid crystal driving electric fields in the adjacent display frames to be opposite.

For example, in at least one example of the method for driving the LCD device, the pixel data voltage and the common voltage are respectively applied to the pixel electrode and the common electrode in the adjacent display frames, so as to allow absolute values of second voltage differences between the pixel electrode and the common electrode to be equal, and allow signs of the second voltage differences to be opposite.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic plan view of an LCD device provided by at least some embodiments of the present disclosure;

FIG. 2 is a schematic sectional view, along the AA′ line, of the LCD device as illustrated in FIG. 1;

FIG. 3 is a schematic diagram of an array substrate of the LCD device as illustrated in FIG. 2;

FIG. 4A is a schematic diagram of a light transmittance adjusting layer provided by at least some embodiments of the present disclosure;

FIG. 4B is a schematic diagram of another light transmittance adjusting layer provided by at least some embodiments of the present disclosure;

FIG. 5A is a diagram illustrating the driving electric field of the array substrate as illustrated in FIG. 3 in a first display frame;

FIG. 5B is a diagram illustrating the driving electric field of the array substrate as illustrated in FIG. 3 in a second display frame;

FIG. 6A is a schematic diagram illustrating the ion exchange of the light transmittance adjusting layer as illustrated in FIG. 4B in a first display frame;

FIG. 6B is a schematic diagram illustrating the ion exchange of the light transmittance adjusting layer as illustrated in FIG. 4B in a second display frame;

FIG. 7A is a schematic sectional view of another LCD device provided by at least some embodiments of the present disclosure;

FIG. 7B is a schematic plan view of a first electrode and a second electrode of the LCD device as illustrated in FIG. 7A;

FIG. 8A is a schematic plan view of an LCD device provided by at least some embodiments of the present disclosure;

FIG. 8B is a schematic sectional view, along the BB′ line, of the LCD device as illustrated in FIG. 8A;

FIG. 9A is a schematic diagram of a second electrode, a light transmittance adjusting layer and a first electrode provided by at least some embodiments of the present disclosure;

FIG. 9B is a schematic diagram illustrating the ion exchange of the light transmittance adjusting layer as illustrated in FIG. 9A in a first display frame; and

FIG. 9C is a schematic diagram illustrating the ion exchange of the light transmittance adjusting layer as illustrated in FIG. 9A in a second display frame.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

The inventor of the present disclosure has noticed that flicker problem may present in an LCD device employing a polarity inversion driving method, that is, when driven by the same grayscale data signal, the brightness of an image in a positive frame is unequal to the brightness of an image in a negative frame, which is caused by the difference between the absolute value of the liquid crystal driving electric field for forming the image in a positive frame and the absolute value of the liquid crystal driving electric field for forming the image in a negative frame. For example, when the image in a positive frame and the image in a negative frame are formed, the absolute values of the differences of the voltages applied to the drive electrodes are equal, but the difference between the absolute value of the liquid crystal driving electric field for forming the image in a positive frame and the absolute value of the liquid crystal driving electric field for forming the image in a negative frame may be caused by at least one of the following factors: the leakage current of the driving transistor of the LCD device, the common voltage offset, the feed through voltage (caused by the parasitic capacitance and the storage capacitance in the LCD device), and various impurity ions in a liquid crystal cell of the LCD device. Exemplary description will be given below to the flicker problem caused by impurity ions in the liquid crystal cell.

For example, when an image in a positive frame is displayed, voltages applied to the common electrode and the pixel electrode are respectively 1V and 3V; when a negative frame image is displayed, voltages applied to the common electrode and the pixel electrode are respectively 1V and −1V; if the voltage formed by the impurity ions in the liquid crystal cell is 0.1V and the direction is the same as the direction of the driving electric field when the image in a positive frame is displayed, the absolute value of the difference of the voltages applied to the liquid crystal layer when the image in a positive frame is displayed is 2.1V, and the absolute value of the difference of the voltages applied to the liquid crystal layer when the image in a negative frame is displayed is 1.9V, Thus, the absolute values of the liquid crystal driving electric fields can be unequal, and the brightness of the image in a positive frame and the image in a negative frame displayed by the LCD device can be different. Therefore, the LCD device has flicker problem.

For example, the flicker level (FL) can be obtained by the following expression: FL=2×(Lmax−Lmin)/(Lmax+Lmin)×100%.

Here, Lmax and Lmin are respectively the maximum brightness and the minimum brightness of the LCD device driven by the same grayscale signal. For example, Lmax and Lmin may be respectively the brightness of the image in a positive frame and the brightness of the image in a negative frame. For another example, Lmax and Lmin may also be the brightness of the image in a negative frame and the brightness of the image in a positive frame respectively.

Because in-vehicle LCD devices have strict requirements on the flicker level, the LCD device with strong flicker (that is, the value of the flicker level is large) may be difficult to be implemented as an in-vehicle LCD device.

At least one embodiment of the present disclosure provides an array substrate, a liquid crystal display (LCD) device and a driving method thereof. The array substrate comprises: a base substrate; and a first electrode, a second electrode and a light transmittance adjusting layer, which are on the base substrate. The first electrode and the second electrode are configured to form a driving electric field, which is between the first electrode and the second electrode and runs through the light transmittance adjusting layer, when the first electrode and the second electrode are respectively applied with a first driving voltage and a second driving voltage; and light transmittance of the light transmittance adjusting layer is adjusted at least partially according to a change in a direction of the driving electric field. In some examples, the array substrate, the LCD device and the driving method thereof may be used to suppress the flicker problem.

Non-limitative descriptions are given to an array substrate, a liquid crystal display device and a driving method thereof provided by at least an embodiment of the present disclosure in the following with reference to a plurality of examples and embodiments. As described in the following, in case of no conflict, different features in these specific examples and embodiments may be combined so as to obtain new examples and embodiments, and the new examples and embodiments are also fall within the scope of present disclosure.

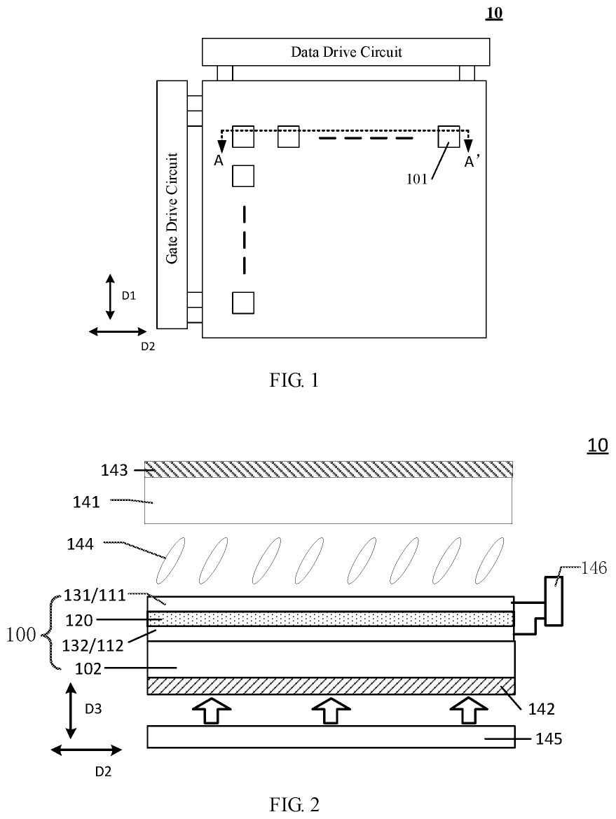

At least one embodiment of the present disclosure provides an array substrate 100. At least one embodiment of the present disclosure further provides an LCD device 10, which comprises the array substrate 100. FIG. 1 is a schematic plan view of the LCD device 10 provided by at least one embodiment of the present disclosure.

As illustrated in FIG. 1, the LCD device 10 comprises a plurality of display subpixels 101 arranged in an array, and a gate drive circuit and a data drive circuit for driving the plurality of display subpixels 101. The plurality of display subpixels 101 are arranged in a plurality of rows in a first direction D1 and are arranged in a plurality of columns in a second direction D2. The LCD device 10 further comprises gate lines, data lines, common voltage lines, etc. Each display subpixel 101 includes a switching element (e.g., a transistor), a pixel electrode and a common electrode. A gate electrode of the switching element is electrically connected with the gate line corresponding to the row provided with the display subpixel; one of a source electrode and a drain electrode of the switching element is electrically connected with the data line corresponding to the column provided with the display subpixel; the pixel electrode is electrically connected with the other one of the source electrode and the drain electrode of the switching element; and the common electrode is electrically connected with the common voltage line. Therefore, whether to charge the pixel electrodes through the switching elements to form the liquid crystal driving electrical fields can be controlled by applying scanning signals to the gate lines and applying data signals to the data lines. It should be noted that the arrangement of the display subpixel 101 as illustrated in FIG. 1 is only illustrative. The LCD device 10 provided by the embodiments of the present disclosure may also adopt other suitable arrangements of display subpixels.

FIG. 2 is a schematic sectional view, along the AA′ line, of the LCD device 10 as illustrated in FIG. 1. For the convenience of description, a drive circuit 146 (for example, a data drive circuit) of the LCD device 10 is also illustrated in FIG. 2. In some examples, FIG. 2 may also be a schematic sectional view, along the AA′ line, of one of the plurality of display subpixels of the LCD device 10 as illustrated in FIG. 1. For example, partial or all the display subpixels 101 in the plurality of display subpixels 101 of the LCD device 10 may adopt the structure as illustrated in FIG. 2. For example, circuit structures such as the gate lines, the data lines and the switching elements are omitted in the figure.

As illustrated in FIG. 2, the LCD device 10 comprises a backlight 145, a first polarizer 142, an array substrate 100, a liquid crystal layer 144, an opposed substrate 141 and a second polarizer 143 which are sequentially arranged (sequentially arranged in a third direction D3). The first polarizer 142 and the second polarizer 143 respectively include a first transmittance axis and a second transmittance axis which are, for example, intersected with each other (for example, perpendicular to each other). For example, the backlight 145 may be implemented as a side-lit backlight, a direct-lit backlight or other applicable backlights. For example, the opposed substrate 141 includes a color filter (CF) layer which includes a plurality of color filters arranged in an array and black matrixes (BMs) arranged between adjacent color filters. For example, the plurality of color filters are in one-to-one correspondence with the plurality of display subpixels 101. For example, the first direction D1, the second direction D2 and the third direction D3 are intersected with each other (for example, perpendicular to each other).

As illustrated in FIG. 2, the backlight 145 is configured to emit light for display towards the array substrate 100. After passing through the first polarizer 142, the light for display is converted into first linearly polarized light, and the polarization direction of the first linearly polarized light is parallel to the first transmittance axis; after running through the liquid crystal layer 144, the first linearly polarized light is converted into second linearly polarized light, and the polarization direction of the second linearly polarized light can rotate correspondingly relative to the polarization direction of the first linearly polarized light according to the liquid crystal driving electric field applied to the liquid crystal layer 144; the second linearly polarized light may include a first polarized component of which the polarization direction is parallel to the second transmittance axis and a second polarized component of which the polarization direction is perpendicular to the second transmittance axis; and after the second linearly polarized light is incident onto the second polarizer 143, the first polarized component may pass through the second polarizer 143 and used for display, and the second polarized component is blocked (for example, absorbed) by the second polarizer 143 and cannot pass through the second polarizer 143. Therefore, the intensity of the first polarized component of the second linearly polarized light can be adjusted by changing the voltage applied to the liquid crystal layer 144, and then the brightness (namely the grayscale) of the display subpixels 101 of the LCD device 10 can be adjusted, and thus the display function can be achieved. For example, the combination of the first polarizer 142, the second polarizer 143 and the liquid crystal layer 144 may be referred to as a liquid crystal light adjusting structure.

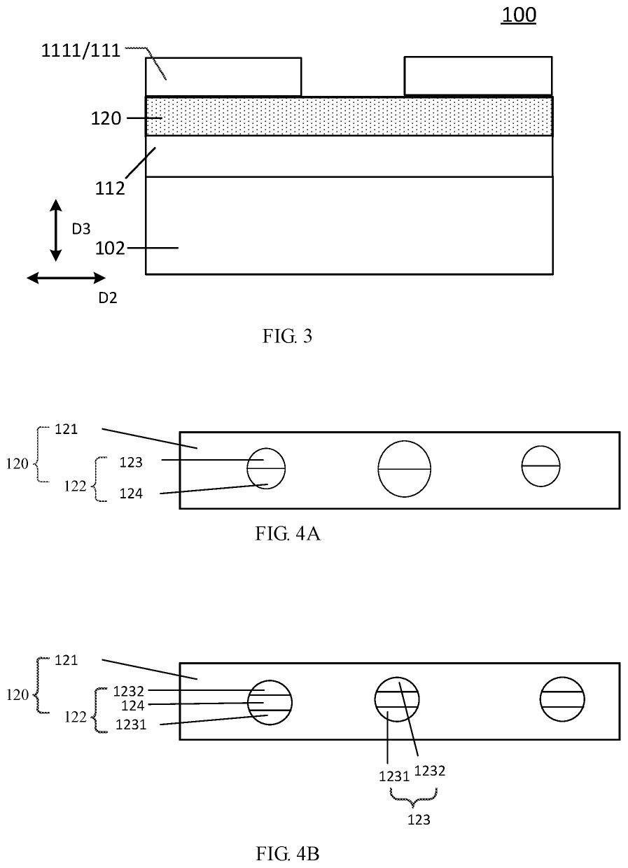

FIG. 3 is a schematic diagram of an array substrate 100 of the LCD device 10 as illustrated in FIG. 2. As illustrated in FIGS. 2 and 3, the array substrate 100 comprises a base substrate 102, and a first electrode 111, a second electrode 112 and a light transmittance adjusting layer 120 which are disposed on the base substrate 102.

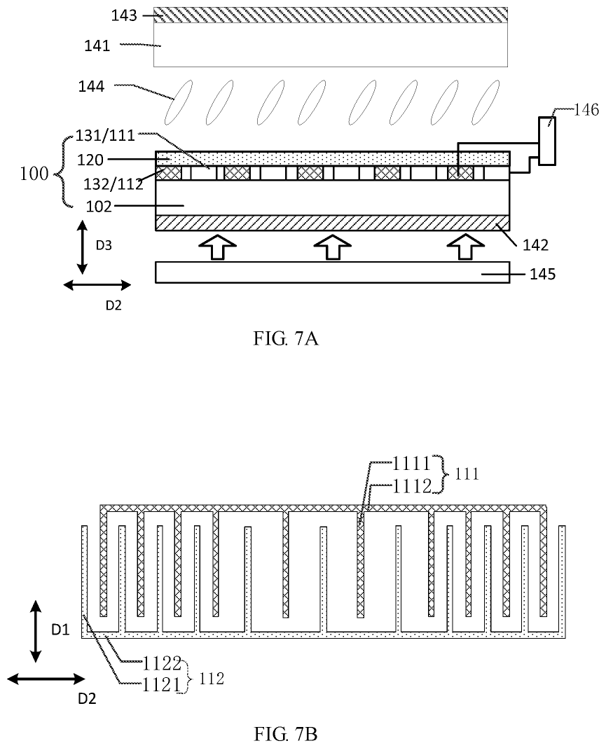

As illustrated in FIG. 3, the second electrode 112, the light transmittance adjusting layer 120 and the first electrode 111 are sequentially arranged on the base substrate 102 along the third direction D3, but the embodiment of the present disclosure is not limited thereto. In some examples, the first electrode 111, the light transmittance adjusting layer 120 and the second electrode 112 are sequentially arranged on the base substrate 102, and the first electrode 111 is closer to the base substrate 102 as compared to the second electrode 112. In some other examples, the first electrode 111 and the second electrode 112 may be arranged on the same side of the light transmittance adjusting layer (for example, arranged in the same structural layer). For the sake of clarity, the example that the first electrode 111 and the second electrode 112 are arranged in the same structural layer will be described in detail in the examples as illustrated in FIGS. 7A and 7B, and no further description will be given here.

It should be noted that, the first electrode 111 and the second electrode 112 may be arranged in the same structural layer means that the first electrode 111 and the second electrode 112 can be obtained through patterning the same film layer with the same patterning process. For example, other “arranged in the same structural layer” in the embodiments of the present disclosure may have similar interpretation, and no further description will be given here.

For example, the base substrate 102 may be a glass substrate, a quartz substrate, a plastic substrate (e.g., a polyethylene terephthalate (PET) substrate) or a transparent substrate made from other applicable materials.

For example, the first electrode 111 and the second electrode 112 include a transparent conductive material. For example, the first electrode 111 and the second electrode 112 may be respectively made from a transparent conductive material. For example, the transparent conductive material may be indium tin oxide (ITO) or indium zinc oxide (IZO).

As illustrated in FIG. 2, the LCD device 10 further comprises a drive circuit 146, and the first electrode 111 and the second electrode 112 are respectively electrically connected with the drive circuit 146. For example, the drive circuit 146 is, for example, a data drive circuit. For another example, the drive circuit 146 may also be implemented as a driver chip which is mounted on the array substrate by bonding and the drive circuit 146 is electrically connected with the first electrode 111 and the second electrode 112 through signal lines, switching elements and the like to apply voltage signals to the first electrode 111 and the second electrode 112.

For example, the first electrode 111 and the second electrode 112 are configured to respectively receive a first driving voltage and a second driving voltage provided by the drive circuit 146, and the first electrode 111 and the second electrode 112 are configured to form a driving electric field, which is between the first electrode 111 and the second electrode 112 and runs through the light transmittance adjusting layer, when the first electrode 111 and the second electrode 112 are respectively applied with the first driving voltage and the second driving voltage.

As illustrated in FIG. 2, the pixel electrode 131 and the common electrode 132 of the display subpixel are used as the first electrode 111 and the second electrode 112, that is, the first electrode 111 is used as the pixel electrode 131 and the second electrode 112 is used as the common electrode 132; the first driving voltage and the second driving voltage are respectively used as the pixel data voltage and the common voltage; and the switching element of the display subpixel and corresponding data line and common voltage line are used as the switching element and the signal line of the first electrode 111 and the second electrode 112. In this case, the driving electric field formed between the first electrode 111 and the second electrode 112 may also be used for forming the liquid crystal driving electric field, namely the driving electric field formed between the first electrode 111 and the second electrode 112 may also be used for driving the liquid crystal molecules in the liquid crystal layer 144 to rotate, so that the display subpixels 101 in the LCD device 10 can display required brightness and grayscale based on the driving electric field.

For example, because the first electrode 111 and the second electrode 112 are respectively used as the pixel electrode 131 and the common electrode 132, compared with the embodiment of independently and respectively providing the first electrode 111 (and the second electrode 112) and the pixel electrode 131 (and the common electrode 132), the manufacturing process can be simplified and the thickness and the production cost of the LCD device 10 can be reduced. For example, the light transmittance adjusting layer 120 may be used as the passivation layer of the LCD device 10 (the passivation layer of a thin-film transistor (TFT)), and no further description will be given here. Therefore, the manufacturing process can be further simplified, and the thickness and the production cost of the LCD device 10 can be further reduced.

For example, as illustrated in FIGS. 2 and 3, the first electrode 111 (namely the pixel electrode 131) includes at least two first sub-electrodes 1111. For example, the at least two first sub-electrodes 1111 are arranged in parallel in the second direction D2, and each first sub-electrode 1111 extends in the first direction D1. It should be noted that for the sake of clarity, FIG. 3 only illustrates two first sub-electrodes 1111, but the embodiment of the present disclosure is not limited thereto. For example, the first electrode 111 may include a plurality of first sub-electrodes 1111 arranged in parallel in the second direction D2. For example, as illustrated in FIGS. 2 and 3, the second electrode 112 (namely the common electrode 132) is a plate-shaped electrode, but the embodiment of the present disclosure is not limited thereto. In some examples, the second electrode 112 may also include a plurality of second sub-electrodes arranged in parallel in the second direction D2, and each second sub-electrode extends in the first direction D1.

For example, the light transmittance of the light transmittance adjusting layer 120 is adjusted at least partially according to the change in the direction of the driving electric field, and therefore, the light transmittance of the light transmittance adjusting layer when the LCD device displays the image in a positive frame is different from the light transmittance of the light transmittance adjusting layer when the LCD device displays the image in a negative frame. For example, the light transmittance adjusting layer 120 includes an electrochromic material; the light transmittance of the light transmittance adjusting layer 120 changes in accordance with the color of the electrochromic material; and the color of the electrochromic material changes in accordance with the change in the direction of the driving electric field, for example, the color of the electrochromic material is darker or lighter. For example, the light absorbing property of the light transmittance adjusting layer 120 can be changed by changing the color of the electrochromic material, and thus the light transmittance of the light transmittance adjusting layer 120 can be changed.

It should be noted that the light transmittance of the light transmittance adjusting layer 120 refers to the transmittance of the light transmittance adjusting layer 120 for the light emitted by the backlight. For example, after the light transmittance adjusting layer 120 changes color, the absorption coefficient of the light transmittance adjusting layer 120 for the light of at least partial colors in the light emitted by the backlight is changed (for example, increased), and then the light transmittance of the light transmittance adjusting layer 120 can be changed (for example, reduced). For example, the light transmittance adjusting layer 120 is disposed in the liquid crystal light adjusting structure.

For example, in the case where the absorption coefficient of the light transmittance adjusting layer 120 for the light of partial color (blue) in the light emitted by the backlight is changed, the display device may further comprise a CF layer and the CF layer may cooperate with the light transmittance adjusting layer 120 to avoid color deviation. For example, when the display subpixel includes a blue filter, because the blue filter can absorb light (i.e., yellow light) complementary to blue, as for the display subpixel including the blue filter, the light transmittance adjusting layer 120 can only change the absorption coefficient for blue light in the light emitted by the backlight. In this case, although the light transmittance adjusting layer 120 cannot adjust the transmittance of other light emitted by the backlight, the other light can be absorbed by the blue filter, and thus color deviation can be avoided.

For example, by arrangement of the light transmittance adjusting layer 120, the luminous brightness of the display subpixel 101 can be further adjusted (for example, finely adjusted, the adjustment range, in the light transmittance, of the light transmittance adjusting layer 120 is less than the adjustment range, in the light transmittance, of the liquid crystal light adjusting structure) according to actual application demands on the basis of adjusting the luminous brightness of the display subpixel 101 by the liquid crystal light adjusting structure. Thus, the luminous brightness of the display subpixel 101 can be more finely adjusted. Therefore, the array substrate 100 and the LCD device 10 provided by some embodiments of the present disclosure have the function of suppressing flicker. For example, the light transmittance adjusting layer 120 is configured to reduce the brightness difference between adjacent frames of images displayed by the LCD device 10 by adjusting the transmittance of the light transmittance adjusting layer 120 (for example, when the absolute values of the data voltages corresponding to the above adjacent frames of images are same). Thus, the array substrate 100 and the LCD device 10 provided by some embodiments of the present disclosure have the function of suppressing flicker.

For example, the electrochromic material and the light transmittance adjusting layer 120 may be set according to actual application demands, and no specific limitation will be given here in the embodiment of the present disclosure. FIG. 4A is a schematic diagram of a light transmittance adjusting layer 120 in at least one embodiment of the present disclosure, and FIG. 4B is a schematic diagram of another light transmittance adjusting layer 120 in at least one embodiment of the present disclosure.

In some examples, as illustrated in FIG. 4A, the light transmittance adjusting layer 120 includes a base 121 and a plurality of particles 122 dispersed in the base 121; each of the plurality of particles 122 includes a first part 123 formed by an ion storage material and a second part 124 formed by the electrochromic material; and the second part 124 changes color (for example, the color is darker or lighter) by exchanging ions with the first part 123 according to the direction of the driving electric field. In some examples, as illustrated in FIG. 4B, the first part 123 includes a first sub-part 1231 and a second sub-part 1232. For example, the first sub-part 1231 is configured to exchange anions with the electrochromic material in the second part 124, and the second sub-part 1232 is configured to exchange cations with the electrochromic material in the second part 124. For example, the second sub-part 1232 may be made from an electrolyte material. The orientations of the first part 123 and the second part 124 of the plurality of particles relative to the first electrode and the second electrode are basically the same (for example, the first sub-part 1231 of each of the plurality of particles is closer to the second electrode 112 compared with the second part 124), and the change of the color of the light transmittance adjusting layer 120 corresponds to the change of the direction of the driving electric field.

It should be noted that, for the sake of clarity, the size of the particle 122 as illustrated in FIG. 4A is enlarged. For example, the size of the particle 122 can be at the nanoscale (i.e., the size of the particle 122 ranges from 1 nm-999 nm). For example, the plurality of particles 122 may be uniformly dispersed in the base 121, so that the light transmittance adjusting layer 120 can have uniform light transmittance.

For example, the base 121 may be implemented as transparent insulating materials. The transparent insulating material may be formed by inorganic or organic materials. For example, the passivation layer may be formed by organic resin, silicon oxide (SiOx), silicon oxynitride (SiNxOy) or silicon nitride (SiNx).

For example, in the case where the transparent insulating material is formed by silicon nitride, the transparent insulating material can better maintain the driving electric field due to large dielectric constant of the silicon nitride, and then the ion exchange between the first part 123 and the second part 124 can be more sufficient, and thus the light transmittance of the light transmittance adjusting layer 120 can be adjusted with better effect.

For the sake of clarity, the working principle of the light transmittance adjusting layer 120 will be described in detail after the description of the driving method of the drive circuit 146, so no further description will be given here.

For example, the light transmittance adjusting layer 120 is configured to have different transmittances in adjacent display frames. For example, the value of the transmittance change period of the light transmittance adjusting layer 120 is the same as the value of the driving period of the liquid crystal light adjusting structure. For example, the light transmittance adjusting layer 120 is configured to reduce the transmittance of the light transmittance adjusting layer 120 when the overall transmittance of the liquid crystal light adjusting structure is increased, so the array substrate 100 and the LCD device 10 provided by some embodiments of the present disclosure have the function of suppressing flicker. For example, the array substrate 100 and the LCD device 10 provided by some embodiments of the present disclosure may be applied in a vehicle display device.

For example, the drive circuit 146 is configured to apply first driving voltage V1 and second driving voltage V2 respectively to the first electrode 111 and the second electrode 112 in adjacent display frames (for example, in a first display frame, and a second frame display adjacent to the first display frame), so that the directions of the driving electric fields in the adjacent display frames can be opposite, and thus the light transmittance of the light transmittance adjusting layer 120 can change towards opposite directions (increased or reduced). For example, in the first display frame, the light transmittance of the light transmittance adjusting layer 120 is reduced at first and then kept stable; and in the second display frame, the light transmittance of the light transmittance adjusting layer 120 is increased at first and then kept stable. It should be noted that the case where the first display frame is adjacent to the second display frame indicates that there is no other display frame between the first display frame and the second display frame.

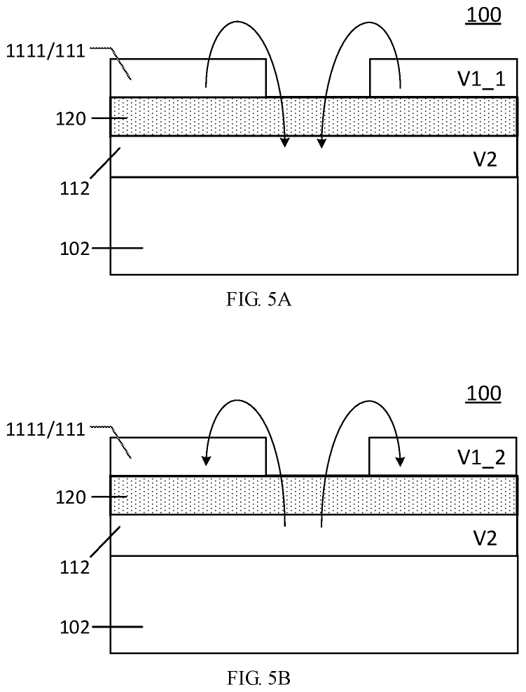

In some examples, the second driving voltages V2 in adjacent display frames can be the same, and the first driving voltages V1 in adjacent display frames can be different from each other. For example, the first driving voltage V1 in the first display frame and the first driving voltage V1 in the second display frame are respectively a first voltage V1_1 and a second voltage V1_2, and the first voltage V1_1 is unequal to the second voltage V1_2. Illustrative description will be given below with reference to FIGS. 5A and 5B.

FIG. 5A is a diagram illustrating the driving electric field of the array substrate 100 as illustrated in FIG. 3 in the first display frame, and FIG. 5B is a diagram illustrating the driving electric field of the array substrate 100 as illustrated in FIG. 3 in the second display frame.

As illustrated in FIG. 5A, in the first display frame, the drive circuit 146 is configured to apply the first voltage V1_1 to the first electrode 111 and apply the second driving voltage V2 to the second electrode 112. For example, the first voltage V1_1 is greater than the second driving voltage V2. As illustrated in FIG. 5A, the driving electric field formed in the first display frame by the first electrode 111 and the second electrode 112 is a first driving electric field; the liquid crystal light adjusting structure as a whole has a first transmittance T1; and the light transmittance adjusting layer 120 has a second transmittance T2. For example, the transmittance of the liquid crystal light adjusting structure as a whole refers to the transmittance of the liquid crystal light adjusting structure when the transmittance of the light transmittance adjusting layer 120 is equal to one.

As illustrated in FIG. 5B, in the second display frame, the drive circuit 146 is configured to apply the second voltage V1_2 to the first electrode 111 and apply the second driving voltage V2 to the second electrode 112. For example, the second voltage V1_2 is less than the second driving voltage V2. As illustrated in FIG. 5B, the driving electric field formed in the second display frame by the first electrode 111 and the second electrode 112 is a second driving electric field; the direction of the second driving electric field and the direction of the first driving electric field are opposite (for example, the first driving electric field has a vertically downward electric field component, and the second driving electric field has a vertically upward electric field component); the liquid crystal light adjusting structure as a whole has a third transmittance T3; and the light transmittance adjusting layer 120 has a fourth transmittance T4.

For example, the absolute values of the first voltage differences between the first electrode 211 and the second electrode 212 in adjacent display frames are equal, in which the first voltage difference is the voltage difference between the voltage on the first electrode 111 and the voltage on the second electrode 112, and the signs of the first voltage differences in the adjacent display frames are opposite (that is, V1_1−V2=V2−V1_2). For example, V1_1, V1_2 and V2 are respectively 3V, −1V and 1V. In this case, 3V−1V=1V−(−1V).

For example, by obtaining the driving electric fields with equal strength and opposite directions through allowing the absolute values of the first voltage differences to be equal and allowing the signs of the first voltage differences to be opposite, the design grayscale in the adjacent display frames can be the same, and the light transmittance of the light transmittance adjusting layer 120 can return to the initial state (initial transmittance) after one driving period (including one first display frame and one second display frame).

For example, in the first display frame, the transmittance of the light transmittance adjusting layer is changed from the fourth transmittance T4 to the second transmittance T2; and in the second display frame, the transmittance of the light transmittance adjusting layer is changed from the second transmittance T2 to the fourth transmittance T4. That is to say, the light transmittance of the light transmittance adjusting layer 120 returns to the initial state after passing through the first display frame and the second display frame, and thus the light transmittance adjusting layer 120 can adjust the brightness and the grayscale of the display subpixel of the LCD device more than one time.

For example, the first transmittance T1 is greater than the third transmittance T3, and the second transmittance T2 is less than the fourth transmittance T4. For example, assuming the intensity of light which is emitted by the backlight 145 and is incident into each display subpixel 101 is L0, the brightness L1 of the display subpixel 101 in the first display frame and the brightness L2 of the display subpixel 101 in the second display frame respectively satisfy the following expressions:

L1=L0×T1×T2;

L2=L0×T3×T4.

Therefore, by allowing the first transmittance T1 to be greater than the third transmittance T3 and allowing the second transmittance T2 to be less than the fourth transmittance T4, the brightness L1 of the display subpixel 101 in the first display frame is closer to the brightness L2 in the second display frame, so the array substrate 100 and the LCD device 10 provided by some embodiments of the present disclosure have the function of suppressing flicker.

For example, by setting the light transmittance adjusting layer, the product of the first transmittance and the second transmittance is equal to the product of the third transmittance and the fourth transmittance, that is, T1×T2=T3×T4. In this case, L1−L2=L0×(T1×T2−T3×T4) =0, namely the brightness Ll of the display subpixel 101 in the first display frame is equal to the brightness L2 in the second display frame. Therefore, the array substrate 100 and the LCD device 10 provided by some embodiments of the present disclosure have better flicker suppression function. For example, the array substrate 100 and the LCD device 10 provided by some embodiments of the present disclosure can suppress flicker completely or substantially completely. For example, the second transmittance of the light transmittance adjusting layer 120 in the first display frame and the fourth transmittance in the second display frame can be adjusted by selecting the type of the electrochromic material and the content (percentage, amount) of the electrochromic material in the electrochromic material layer. For example, the specific method of adjusting the transmittance of the light transmittance adjusting layer 120 by selecting the type of the electrochromic material and the content (percentage, amount) of the electrochromic material in the electrochromic material layer may refer to relevant technology, and no further description will be given here.

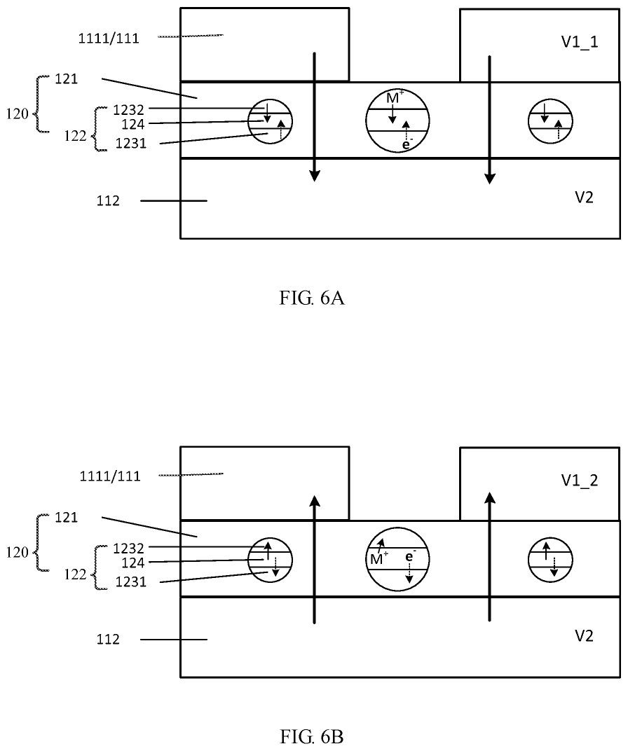

For example, illustrative description will be given below to the color change principle and the light transmittance adjusting principle of the light transmittance adjusting layer 120 with reference to FIGS. 6A and 6B by taking the light transmittance adjusting layer 120 as illustrated in FIG. 4B as an example. FIG. 6A is a schematic diagram illustrating the ion exchange of the light transmittance adjusting layer 120 as illustrated in FIG. 4B in the first display frame, and FIG. 6B is a schematic diagram illustrating the ion exchange of light transmittance adjusting layer 120 as illustrated in FIG. 4B in the second display frame.

For example, as illustrated in FIGS. 6A and 6B, the electrochromic material in the second part 124 is tungsten oxide (WO₃); the first sub-part 1231 of the first part 123 may be used for providing electrons e⁻ for the second part 124; the second sub-part 1232 of the first part 123 may be used for providing cations M⁺ for the second part 124; and the cation, for example, may be hydrogen ion (H⁺) or lithium ion (Li⁺). For example, the first sub-part 1231 may be made from conductive materials, and the second sub-part 1232 may be made from an ion storage material for the electrochromic material. In addition, the electrochromic material, for example, may adopt appropriate inorganic electrochromic material (for example, transition metal oxide) or organic electrochromic material. The ion storage material, for example, includes solid electrolyte (lithium titanate, lithium borate, lithium fluoride, etc.); or the ion storage material includes another electrochromic material complementary to the foregoing electrochromic material, such that a double active layer structure is formed. When an electric field is applied to cause electrons and ions to be transported from one active layer to another, the same color change reaction occurs in the two active layer, e.g., from dark to light (i.e., from a colored state to a faded state); and when a reverse electric field is applied, reversed color change reaction occurs simultaneously in the two active layer. For example, nickel hydroxide Ni(OH)₂ and tungsten oxide may be combined to realize the double active layer structure; electrons and hydrogen ions required for the reduction of tungsten oxide to dark tungsten bronze (HWO₃) are just provided by oxidizing nickel hydroxide into dark basic nickel oxide (NiOOH), the colors of the two active layer are lighter at the same time in a reversed process. For example, due to small size of the particles 122, the particles 122 dispersed in the base 121 will not affect the overall electrical property (e.g., electrical insulation property) of the light transmittance adjusting layer 120.

As illustrated in FIG. 6A, in the first display frame, the direction of the driving electric field (the first driving electric field) formed between the first electrode 111 and the second electrode 112 is from the first electrode 111 to the second electrode 112, so the first driving electric field allows the cations M⁺ in the second sub-part 1232 to be transported to the second part 124 and allows the electrons e⁻ in the first sub-part 1231 to be transported to the second part 124. In this case, M⁺, e⁻ and WO₃ in the second part 124 are combined to form tungsten bronze (MₓWO₃), namely xM⁺xe⁻+WO₃=MₓWO₃. Therefore, in the first display frame, the color of the light transmittance adjusting layer 120 is gradually darker, and in this case, the absorption coefficient of the light transmittance adjusting layer 120 for the light emitted by the backlight is increased, and the light transmittance of the light transmittance adjusting layer 120 is reduced.

As illustrated in FIG. 6B, in the second display frame, the direction of the driving electric field (the second driving electric field) formed between the first electrode 111 and the second electrode 112 is from the second electrode 112 to the first electrode 111, so the second driving electric field allows the cations M⁺ in the second part 124 to be transported to the second sub-part 1232 and allows the electrons e⁻ in the second part 124 to be transported to the first sub-part 1231. In this case, M⁺ and e⁻ in the second part 124 are separated from WO₃. Therefore, the color of the light transmittance adjusting layer 120 is gradually lighter, and in this case, the absorption coefficient of the light transmittance adjusting layer 120 for the light emitted by the backlight is reduced, and the light transmittance of the light transmittance adjusting layer 120 is increased.

For example, according to actual application demands, the color of the electrochromic material can also be darker or lighter by only exchanging cations with the ion storage materials or by only exchanging anions with the ion storage materials. In this case, the first part 123 may adopt the structure as illustrated in FIG. 4A, and no further description will be given here.

It should be noted that the specific materials of the first sub-part 1231, the second sub-part 1232 and the second part 124 in the embodiment of the present disclosure can be set according to actual application demands, and no specific limitation will be given here in the embodiment of the present disclosure.

FIG. 7A is a schematic sectional view of another LCD device 10 provided by at least one embodiment of the present disclosure. For the convenience of description, FIG. 7A also illustrates the drive circuit 146 of the LCD device 10. The LCD device 10 as illustrated in FIG. 7A is similar to the LCD device 10 as illustrated in FIG. 2. Only the differences are explained here, and the similarities are not repeated here.

For example, as illustrated in FIG. 7A, the first electrode 111 and the second electrode 112 are arranged in the same structural layer. For example, the first electrode 111 and the second electrode 112 can be obtained by patterning the same conductive layer (for example, the first electrode 111 and the second electrode 112 can be obtained by the same patterning process).

FIG. 7B is a schematic plan view of the first electrode 111 and the second electrode 112 of the LCD device 10 as illustrated in FIG. 7A. It should be noted that, for the sake of clarity, FIG. 7B only illustrates the first electrode 111 and the second electrode 112 of one of the plurality of display subpixels.

As illustrated in FIG. 7B, the first electrode 111 and the second electrode 112 respectively include a plurality of first sub-electrodes 1111 and a plurality of second sub-electrodes 1121; the plurality of first sub-electrodes 1111 and the plurality of second sub-electrodes 1121 are respectively extended along the first direction D1; and the plurality of first sub-electrodes 1111 and the plurality of second sub-electrodes 1121 are alternately arranged in the second direction D2 intersected with (perpendicular to) the first direction D1. For example, as illustrated in FIG. 7B, the first electrode 111 may also include a first connecting electrode 1112, the second electrode 112 may also include a second connecting electrode 1122, and the first connecting electrode and the second connecting electrode 1122 respectively extend along the second direction D2. The plurality of first sub-electrodes 1111 are electrically connected with each other through the first connecting electrode 1112, and the plurality of second sub-electrodes 1121 are electrically connected with each other through the second connecting electrode 1122, and thus, it is in favor of simultaneously applying the first driving voltage to the plurality of first sub-electrodes 1111 and simultaneously applying the second driving voltage to the plurality of second sub-electrodes 1121. For example, as illustrated in FIG. 7B, the first electrode 111 and the second electrode 112 may be respectively implemented as a comb electrode.

It should be noted that the spacing between the first sub-electrode 1111 and the second sub-electrode 1121 which are adjacent to each other is not limited to the mode as illustrated in FIG. 7B (that is, the middle area is large and the areas on two sides are small). For example, the spacings between the first sub-electrodes 1111 and the second sub-electrodes 1121 which are adjacent to each other (for example, the spacing in the second direction D2) may also be equal to each other.

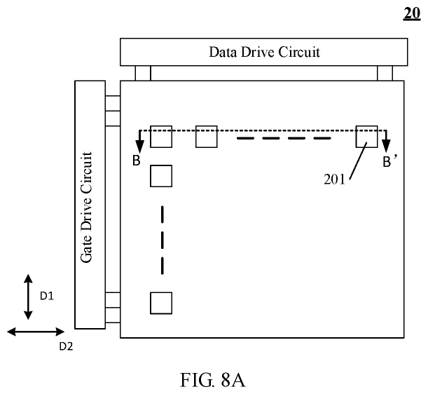

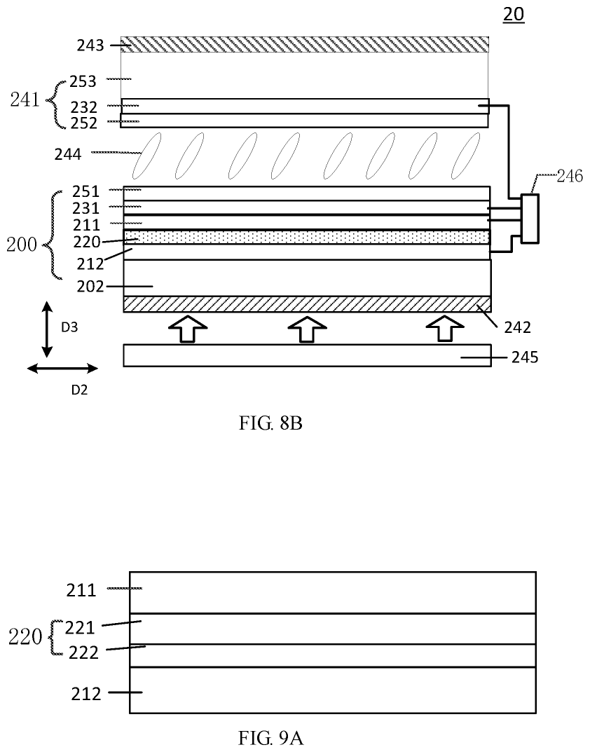

FIG. 8A is a schematic plan view of an LCD device 20 provided by at least one embodiment of the present disclosure. As illustrated in FIG. 8A, the LCD device 20 comprises a plurality of display subpixels 201 arranged in an array, and a gate drive circuit and a data drive circuit for driving the plurality of display subpixels 201. The plurality of display subpixels 201 are respectively arranged in a plurality of rows in the first direction D1 and a plurality of columns in the second direction D2. The LCD device 20 further comprises a plurality of gate lines, data lines, etc. Each display subpixel 201 includes a switching element (e.g., a transistor). A gate electrode of the switching element is electrically connected with the gate line corresponding to the row provided with the display subpixel; one of a source electrode and a drain electrode of the switching element is electrically connected with the data line corresponding to the column provided with the display subpixel; and the pixel electrode is electrically connected with the other one of the source electrode and the drain electrode of the switching element. Therefore, whether to charge the pixel electrodes to form the liquid crystal driving electric fields via the switching elements may be controlled by applying scanning signals to the gate lines and applying data signals to the data lines. It should be noted that the arrangement of the display subpixels 201 as illustrated in FIG. 8A is only an example, and the LCD device 20 provided by the embodiment of the present disclosure may also adopt other applicable arrangements of display subpixels.

FIG. 8B is a schematic sectional view, along the BB′ line, of the LCD device 20 as illustrated in FIG. 8A. For the convenience of description, FIG. 8B also illustrates the drive circuit 246 (for example, a data drive circuit) of the LCD device 20. In some examples, FIG. 8B may also be a schematic sectional view of one of the plurality of display subpixels 201 of the LCD device 20 as illustrated in FIG. 8A along the BB′ line.

As illustrated in FIG. 8B, the LCD device 20 comprises a backlight 245, a first polarizer 242, an array substrate 200, a liquid crystal layer 244, an opposed substrate 241 and a second polarizer 243 which are sequentially arranged along the third direction D3. The first polarizer 242 and the second polarizer 243 respectively include a first transmittance axis and a second transmittance axis, and the first transmittance axis and the second transmittance axis are, for example, intersected with (for example, perpendicular to) each other.

For example, the combination of the first polarizer 242, the liquid crystal layer 244 and the second polarizer 243 as illustrated in FIG. 8B may be referred to as a liquid crystal light adjusting structure. For example, the working principle of the liquid crystal light adjusting structure as illustrated in FIG. 8B is similar to that of the liquid crystal light adjusting structure as illustrated in FIG. 2, so no further description will be given here. The difference between the liquid crystal light adjusting structure as illustrated in FIG. 8B and the liquid crystal light adjusting structure as illustrated in FIG. 2 is that the liquid crystal light adjusting structure as illustrated in FIG. 8B is a vertical electric field type liquid crystal light adjusting structure, and the liquid crystal light adjusting structure as illustrated in FIG. 2 is a horizontal electric field type liquid crystal light adjusting structure.

As illustrated in FIG. 8B, the array substrate 200 includes a base substrate 202, and a second electrode 212, a light transmittance adjusting layer 220, a first electrode 211, an insulating layer (not shown in FIG. 8B), a pixel electrode 231 and a first alignment layer 251 which are sequentially arranged on the base substrate 202; and the opposed substrate 241 includes a second alignment layer 252, a common electrode 232 and a CF layer 253 which are sequentially arranged.

The combination of the light transmittance adjusting layer 220, the first electrode 211 and the second electrode 212 of the LCD device 20 as illustrated in FIG. 8B and the liquid crystal light adjusting structure are separately arranged (for example, superimposed to each other). Therefore, compared with the LCD device 10 as illustrated in FIG. 2, the array substrate 200 may further include switching elements, signal lines and the like which are independently and additionally provided for the first electrode 211 and the second electrode 212. For example, the array substrate 200 further includes second gate lines, second data lines and common voltage lines; each display subpixel further includes a second switching element; the gate electrode of the second switching element is electrically connected with the second gate line corresponding to the row provided with the display subpixel; one of the source electrode and the drain electrode of the second switching element is electrically connected with the second data line corresponding to the column provided with the display subpixel; the first electrode 211 is electrically connected with the other one of the source electrode and the drain electrode of the second switching element (and then can receive data signals); and the second electrode 212 is electrically connected with the common voltage line (and then can receive, for example, a common voltage with a fixed value). Therefore, whether to charge the first electrodes 211 to form the driving electric fields for adjusting the light transmittances through the second switching elements can be controlled by applying scanning signals to the second gate lines and applying data signals (for adjusting the light transmittance) to the second data lines. For example, as for each display subpixel, the scanning signal and the data signal for forming the liquid crystal driving electric field and the scanning signal and the data signal for forming the light transmittance adjustment driving electric field are synchronously applied. For example, the amplitude of the data signal for forming the liquid crystal driving electric field and the amplitude of the data signal for forming the light transmittance adjustment driving electric field can be in positive correlation, for example, the ration between the amplitude of the data signal for forming the liquid crystal driving electric field and the amplitude of the data signal for forming the light transmittance adjustment driving electric field is a fixed value. Therefore, the LCD device 20 as illustrated in FIG. 8B can adjust the transmittance of the light transmittance adjusting layer 220 in each display subpixel 201 according to the flicker condition of each display subpixel 201. Therefore, in the case where the grayscales corresponding to the data signals received by the plurality of subpixels of the LCD device 20 are the same, the LCD device 20 as illustrated in FIG. 8B allows the plurality of subpixels to have uniform display brightness and grayscale, and thus the display quality of the LCD device 20 can be improved.

For example, by allowing the absolute values of the first voltage differences (the first voltage difference is the voltage difference between the voltage on the first electrode 211 and the voltage on the second electrode 212) in the adjacent display frames to be equal, and allowing the signs of the first voltage differences in the adjacent display frames to be opposite, the light transmittance of the light transmittance adjusting layer 220 returns to the initial state (initial transmittance) after one driving period (including one first display frame and one second display frame), and thus the brightness and the grayscale of the display subpixel 201 of the LCD device 20 can be adjusted more than one time.

It should be noted that according to actual application demands, the absolute values of the first voltage differences between the first electrode 211 and the second electrode 212 in the adjacent display frames may also be unequal. For example, in other examples and embodiments, the absolute values of the first voltage differences between the first electrode and the second electrode in the adjacent display frames may also be unequal. No further description will be given here.

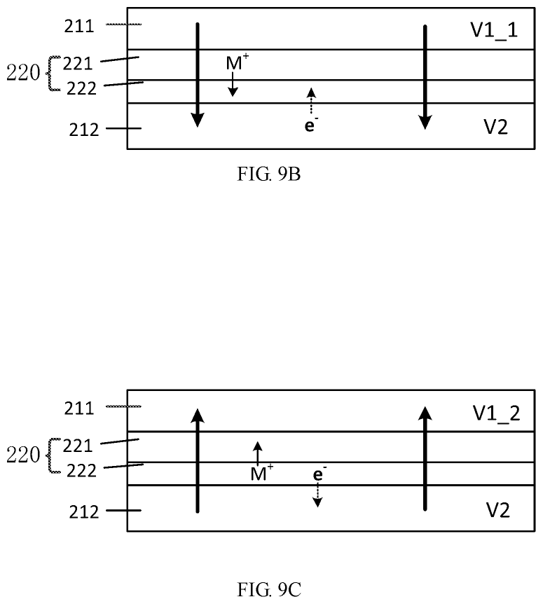

FIG. 9A is a schematic diagram of the second electrode 212, the light transmittance adjusting layer 220 and the first electrode 211 in at least one embodiment of the present disclosure. As illustrated in FIG. 9A, the light transmittance adjusting layer 220 includes an ion storage layer 221 and an electrochromic material layer 222 which are superimposed to and in contact with each other; the electrochromic material layer 222 includes an electrochromic material; and the electrochromic material layer 222 changes color by exchanging ions with the ion storage layer 211 according to the change in the direction of the driving electric field.

For example, the electrochromic material layer 222 is in direct contact with the second electrode 212, so as to exchange ions with the second electrode 212 according to the change in the direction of the driving electric field. For example, the ion storage layer 221 and the electrochromic material exchange cations. For example, the ion storage layer 221 is made from electrolyte materials.

Illustrative description will be given below to the color change principle and the light transmittance adjusting principle of the light transmittance adjusting layer 220 with reference to FIGS. 9B and 9C by taking the light transmittance adjusting layer 220 as illustrated in FIG. 9A as an example. FIG. 9B is a schematic diagram illustrating the ion exchange of the light transmittance adjusting layer 220 as illustrated in FIG. 9A in the first display frame, and FIG. 9C is a schematic diagram illustrating the ion exchange of the light transmittance adjusting layer 220 as illustrated in FIG. 9A in the second display frame.

For example, the electrochromic material of the electrochromic material layer 222 is tungsten trioxide (WO₃); the second electrode 212 may be used for providing electrons for the light transmittance adjusting layer 220; the ion storage layer 221 may be used for providing cations M⁺ for the electrochromic material layer 222; and the cation, for example, may be hydrogen ion (H⁺) or lithium ion (Li⁺).

As illustrated in FIG. 9B, in the first display frame, the drive circuit 246 applies the first voltage V1_1 and the second driving voltage V2 respectively to the first electrode 211 and the second electrode 212, and the first voltage V1_1 is greater than the second driving voltage V2. Therefore, the direction of the driving electric field (the first driving electric field) formed between the first electrode 211 and the second electrode 212 is from the first electrode 211 to the second electrode 212, and the first driving electric field allows the cations M⁺ in the ion storage layer 221 to be transported to the electrochromic material layer 222 and allows the electrons e⁻ in the second electrode 212 to be transported to the electrochromic material layer 222. In this case, M⁺, e⁻ and WO₃ in the electrochromic material layer 222 are mutually combined to form tungsten bronze (MₓWO₃, and the color is for example bluish), that is, xM³⁰ +xe⁻+WO₃=MₓWO₃. The color of the light transmittance adjusting layer 220 is gradually darker. In this case, the absorption coefficient of the light transmittance adjusting layer 220 for the light emitted by the backlight is increased, and the light transmittance of the light transmittance adjusting layer 220 is reduced.

As illustrated in FIG. 9C, in the second display frame, the drive circuit 246 applies the second voltage V1_2 and the second driving voltage V2 respectively to the first electrode 211 and the second electrode 212, and the second voltage V1_2 is less than the second driving voltage V2. Therefore, the direction of the driving electric field (the second driving electric field) formed between the first electrode 211 and the second electrode 212 is from the second electrode 212 to the first electrode 211, and the second driving electric field allows the cations M⁺ in the electrochromic material layer 222 to be transported to the ion storage layer 221 and allows the electrons e⁻ in the electrochromic material layer 222 to be transported to the second electrode 212. In this case, M⁺ and e⁻ in the electrochromic material layer 222 are separated from WO₃, and the color of the light transmittance adjusting layer 220 is gradually lighter. In this case, the absorption coefficient of the light transmittance adjusting layer 220 for the light emitted by the backlight is reduced, and the light transmittance of the light transmittance adjusting layer 220 is increased.

It should be noted that the specific material of the electrochromic material layer 222 and the ion storage layer 221 in the embodiment of the present disclosure can be set according to actual application demands (for example, according to the wavelength required to be adjusted), and no specific limitation will be given here in the embodiment of the present disclosure.

For example, the pixel electrode 231 is configured to be applied with a pixel data voltage, and the common electrode 232 is configured to be applied with a common voltage. The pixel electrode 231 and the common electrode 232 are configured to form a liquid crystal driving electric field, which is between the pixel electrode 231 and the common electrode 232 and runs through the liquid crystal layer 244, when the pixel electrode 231 and the common electrode 232 are respectively applied with the pixel data voltage and the common voltage. Liquid crystal molecules in the liquid crystal layer 244 rotate for corresponding angle (so that the display subpixel 201 can have required brightness and grayscale) according to the value of the liquid crystal driving electric field (the absolute value of the voltage difference between the pixel electrode 231 and the common electrode 232), and the rotation direction is changed along with the change in the direction of the liquid crystal driving electric field.

For example, in adjacent display frames (for example, in a first display frame and a second display frame adjacent to the first display frame), the drive circuit 246 is configured to apply the pixel data voltage and the common voltage respectively to the pixel electrode 231 and the common electrode 232, and allows the directions of the driving electric fields in the adjacent display frames to be opposite, thereby avoiding the problem that the liquid crystal molecules are damaged and cannot be restored when the liquid crystal molecules continue to rotate along one direction.

For example, the pixel data voltage and the common voltage are respectively applied to the pixel electrode 231 and the common electrode 232 in the adjacent display frames, so that the absolute values of the second voltage differences (the second voltage difference is the voltage difference between the voltage on the pixel electrode 231 and the voltage on the common electrode 232) between the pixel electrode 231 and the common electrode 232 in the adjacent display frames can be equal (the same), and the signs of the second voltage differences can be opposite (for example, can be respectively “+” and “−”). Therefore, the driving electric fields with same strength but opposite directions are obtained, and thus the design grayscale in the adjacent display frames can be the same. It should be noted that according to actual application demands, the absolute values of the second voltage differences between the pixel electrode 231 and the common electrode 232 in the adjacent display frame may also be unequal (may not be the same). For example, in other examples and embodiments, the absolute values of the second voltage differences between the pixel electrode and the common electrode in the adjacent display frames may also be unequal, and no further description will be given here.

For example, the material and the setting mode of the base substrate 202, the second electrode 212 and the first electrode 211 may refer to the example as illustrated in FIG. 2, so no further description will be given here. For example, the first alignment layer 251 and the second alignment layer 252 are configured to allow the liquid crystal molecules to be regularly arranged, and then better display effect can be achieved. For example, the first alignment layer 251 and the second alignment layer 252 can be obtained by friction alignment technology and optical alignment technology.

The following points should be noted.

(1) According to actual application demands, the LCD device as illustrated in FIG. 2 can further comprise a pixel electrode and a common electrode which are electrically insulated with each other; and the pixel electrode and the common electrode are disposed on a side of the combination structure of the first electrode, the second electrode and the light transmittance adjusting layer away from the base substrate, and the pixel electrode and the common electrode are respectively configured to be applied with a pixel data voltage and a common voltage. In this case, the pixel electrode and the common electrode can be arranged in the same structural layer or in different structural layers. When the pixel electrode and the common electrode are arranged in the same structural layer, the specific structure of the pixel electrode and the common electrode may be similar to the first electrode and the second electrode as illustrated in FIG. 7B, and no further description will be given here. For example, by allowing the LCD device as illustrated in FIG. 2 to further comprise the pixel electrode and the common electrode which are electrically insulated, the LCD device as illustrated in FIG. 2 can also adjust the transmittance of the light transmittance adjusting layer in each display subpixel according to the flicker condition of each display subpixel, and thus the display quality of the LCD device as illustrated in FIG. 2 can be improved.

(2) According to actual application demands, the LCD device as illustrated in FIG. 8B may also be not provided with the pixel electrode, and in this case, the first electrode of the LCD device as illustrated in FIG. 8B can be used as the pixel electrode, and the first electrode cooperates with the common electrode to drive the liquid crystal molecules in the liquid crystal layer to rotate, and then the display subpixel of the LCD device can display required brightness and grayscale. In this case, the manufacturing process can be simplified, and the thickness and the production cost of the LCD device can be reduced.

(3) According to actual application demands, the LCD device as illustrated in FIG. 8B may also adopt the light transmittance adjusting layer as illustrated in FIGS. 6A and 6B, and the LCD device as illustrated in FIG. 2 may also adopt the light transmittance adjusting layer as illustrated in FIG. 9A. No further description will be given here.

(4) According to actual application demands, the LCD device as illustrated in FIG. 2 may also be provided with the first alignment layer and the second alignment layer.

(5) The light transmittance of the light transmittance adjusting layer in the embodiment of the present disclosure can also be adjusted according to the change in the direction of the driving electric field based on other principles. In some examples, a material whose band gap can be adjusted in accordance with the change in the direction of the driving electric field can be selected. Because the band gap of the material affects the absorption property of the material, the light transmittance of the light transmittance adjusting layer can be adjusted in accordance with the change in the direction of the driving electric field by selecting the material whose band gap (or energy gap) can be adjusted according to the change in the direction of the driving electric field as at least partial material of the light transmittance adjusting layer. For example, when the electric field applied to silicon carbide/boron nitride (SiC/BN) materials changes from −0.50 to +0.65 V/Å, the band gap of the material is changed from 2.41 eV to 0 eV.

(6) It should be understood by those skilled in the art that other components (for example, TFTs, an image data encoding/decoding device, a clock circuit, etc.) of the array substrate and the LCD device provided by the embodiment of the present disclosure may adopt applicable components, which will not be further described here and should not be construed as the limitation on the present disclosure.

At least one embodiment of the present disclosure further provides a method for driving an LCD device. The driving method may be used for driving the LCD device provided by any embodiment of the present disclosure. The driving method may be used for driving the display device as illustrated in FIG. 2, the display device as illustrated in FIG. 8B or other applicable display devices. For example, the driving method of the LCD device applies the first driving voltage and the second driving voltage to the first electrode and the second electrode in adjacent display frames, so that the directions of the driving electric fields in the adjacent display frames can be opposite (for example, can be respectively “+” and “−”, or can be respectively “−” and “+”).

For example, by allowing the directions of the driving electric fields in the adjacent display frames to be opposite, the light transmittance of the light transmittance adjusting layer can be adjusted at least partially according to the change in the direction of the driving electric field. Thus, the luminous brightness of the display subpixel can be further adjusted (for example, finely adjusted, and the adjustment range, in the light transmittance, of the light transmittance adjusting layer is less than the adjustment range, in the light transmittance, of the liquid crystal light adjusting structure) according to actual application demands on the basis of adjusting the luminous brightness of the display subpixel by the liquid crystal light adjusting structure. Therefore, the luminous brightness and the grayscale of the display subpixel can be more finely adjusted, and some array substrates and LCD devices employing the driving method can have the function of suppressing flicker.

For example, in adjacent display frames (for example, in a first display frame and a second display frame adjacent to the first display frame), the drive circuit is configured to apply the first driving voltage VI and the second driving voltage V2 respectively to the first electrode and the second electrode, so that the absolute values of the first voltage differences between the first electrode and the second electrode in the adjacent display frames can be equal, and the signs of the first voltage differences in the adjacent display frames can be opposite. Therefore, the light transmittance of the light transmittance adjusting layer can return to the initial state (initial transmittance) after one driving period (including one first display frame and one second display frame).

In some examples, the second driving voltage V2 in adjacent display frames can be the same, and the first driving voltage V1 in adjacent display frames can be different from each other. For example, the first driving voltage V1 in the first display frame and the first driving voltage V1 in the second display frame are respectively the first voltage V1_1 and the second voltage V1_2.

In some examples, the second driving voltage V2 in adjacent display frames can be different from each other, and the first driving voltage VF 1 in adjacent display frames can be different from each other. For example, in the adjacent display frames, the case where the drive circuit is configured to apply the first driving voltage V1 and the second driving voltage V2 respectively to the first electrode and the second electrode includes: in the first display frame, applying a third voltage V3 and a fourth voltage V4 respectively to the first electrode and the second electrode; and in the second display frame, applying the fourth voltage V4 and the third voltage V3 respectively to the first electrode and the second electrode. For example, the third voltage V3 is greater than the fourth voltage V4.

For example, the LCD device further comprises a liquid crystal light adjusting structure; the liquid crystal light adjusting structure includes a liquid crystal layer, a pixel electrode and a common electrode; and the pixel electrode and the common electrode are respectively applied with the pixel data voltage and the common voltage to form a liquid crystal driving electric field for controlling the rotation of liquid crystal molecules in the liquid crystal layer. In some examples, the first electrode and the second electrode are respectively used as the pixel electrode and the common electrode, and the first driving voltage and the second driving voltage are respectively used as the pixel data voltage and the common voltage. In some examples, the LCD device comprises all of the pixel electrode, the common electrode, the first electrode and the second electrode, and the pixel electrode and the common electrode are disposed on the side of the combination structure of the first electrode, the second electrode and the light transmittance adjusting layer away from the base substrate.

For example, the driving method provided by at least one embodiment of the present disclosure further comprises: applying the pixel data voltage and the common voltage to the pixel electrode and the common electrode in adjacent display frames, so that the directions of the liquid crystal driving electric fields in the adjacent display frames can be opposite, thereby avoiding the problem that the liquid crystal molecules are damaged and cannot be restored when the liquid crystal molecules continuously rotate towards one direction.

For example, by allowing the pixel data voltage and the common voltage are respectively applied to the pixel electrode and the common electrode in the adjacent display frames to allow the absolute values of the second voltage differences between the pixel electrode and the common electrode in the adjacent display frames to be equal, and to allow the signs of the second voltage differences to be opposite, the theoretical grayscale in the adjacent display frames can be the same. For example, by arrangement of the light transmittance adjusting layer, the difference between the actual grayscales in adjacent display frames can be reduced, and thus the flicker problem, caused by deviation of the actual grayscale of the display frame from the theoretical grayscale, can be suppressed.

Although detailed description has been given above to the present disclosure with general description and embodiments, it shall be apparent to those skilled in the art that some modifications or improvements may be made on the basis of the embodiments of the present disclosure. Therefore, all the modifications or improvements made without departing from the spirit of the present disclosure shall all fall within the scope of protection of the present disclosure.

What are described above is related to the illustrative embodiments of the disclosure only and not limitative to the scope of the disclosure; the scopes of the disclosure are defined by the accompanying claims.

What is claimed is:

1. An array substrate, comprising:
a base substrate; and
a first electrode, a second electrode and a light transmittance adjusting layer, which are on the base substrate,
wherein the first electrode and the second electrode are configured to form a driving electric field, which is between the first electrode and the second electrode and runs through the light transmittance adjusting layer, when the first electrode is applied with a first driving voltage and the second electrode is applied with a second driving voltage; and
light transmittance of the light transmittance adjusting layer is configured to be adjusted at least partially according to a change in a direction of the driving electric field.

2. The array substrate according to claim 1, wherein the light transmittance adjusting layer comprises an electrochromic material;
the light transmittance of the light transmittance adjusting layer is configured to change in accordance with color of the electrochromic material; and
the color of the electrochromic material is configured to change in accordance with the change in the direction of the driving electric field.

3. The array substrate according to claim 2, wherein the light transmittance adjusting layer comprises an ion storage layer and an electrochromic material layer which are superimposed to and in contact with each other, and the electrochromic material layer comprises the electrochromic material; and
the electrochromic material layer is configured to change color by exchanging ions with the ion storage layer according to the change in the direction of the driving electric field.

4. The array substrate according to claim 2, wherein the light transmittance adjusting layer comprises a base and a plurality of particles dispersed in the base;
each of the plurality of particles comprises a first part formed by an ion storage material and a second part formed by the electrochromic material; and
the second part is configured to change color by exchanging ions with the first part according to the direction of the driving electric field.

5. The array substrate according to claim 2, wherein the first electrode and the second electrode are respectively on different sides of the light transmittance adjusting layer relative to the base substrate.

6. The array substrate according to claim 2, wherein the first electrode and the second electrode are on a same side of the light transmittance adjusting layer relative to the base substrate.

7. The array substrate according to claim 6, wherein the first electrode and the second electrode are in a same structural layer.

8. The array substrate according to claim 7, wherein the first electrode comprises a plurality of first sub-electrodes, and the second electrode comprises a plurality of second sub-electrodes;
the plurality of first sub-electrodes and the plurality of second sub-electrodes respectively extend along a first direction; and
the plurality of first sub-electrodes and the plurality of second sub-electrodes are alternately arranged in a second direction intersected with the first direction.

9. The array substrate according to claim 1, wherein the first electrode and the second electrode comprise a transparent conductive material.

10. The array substrate according to claim 9, wherein the first electrode is used as a pixel electrode, and the second electrode is used as a common electrode; and
the first driving voltage is used as a pixel data voltage, and the second driving voltage is used as a common voltage.

11. The array substrate according to claim 9, further comprising a pixel electrode,
wherein the pixel electrode is on a side of a combination structure of the first electrode, the second electrode and the light transmittance adjusting layer away from the base substrate; and
the pixel electrode is configured to be applied with a pixel data voltage.

12. A liquid crystal display (LCD) device, comprising an array substrate,
wherein the array substrate comprises a base substrate, and a first electrode, a second electrode and a light transmittance adjusting layer, which are on the base substrate;
the first electrode and the second electrode are configured to form a driving electric field, which is between the first electrode and the second electrode and runs through the light transmittance adjusting layer, when the first electrode is applied with a first driving voltage and the second electrode is applied with a second driving voltage; and
light transmittance of the light transmittance adjusting layer is configured to be adjusted at least partially according to a change in a direction of the driving electric field.

13. The LCD device according to claim 12, further comprising a drive circuit,
wherein the drive circuit is configured to apply the first driving voltage to the first electrode and apply the second driving voltage to the second electrode in adjacent display frames, so as to allow directions of driving electric fields in the adjacent display frames to be opposite.

14. The LCD device according to claim 13, wherein the first driving voltage, which is applied to the first electrode in the adjacent display frames, and the second driving voltage, which is applied to the second electrode in the adjacent display frames, allow absolute values of first voltage differences between the first electrode and the second electrode in the adjacent display frames to be equal, and allow signs of the first voltage differences in the adjacent display frames to be opposite.

15. A method for driving an LCD device, comprising:
applying a first driving voltage to a first electrode of an array substrate of the LCD device and a second driving voltage to a second electrode of the array substrate of the LCD device in adjacent display frames, so as to allow directions of driving electric fields in the adjacent display frames to be opposite,
wherein the array substrate further comprises a base substrate and a light transmittance adjusting layer;
the first electrode, the second electrode and the light transmittance adjusting layer are on the base substrate;
the driving electric fields are formed when the first electrode is applied with the first driving voltage and the second electrode is applied with the second driving voltage;
the driving electric fields are between the first electrode and the second electrode and run through the light transmittance adjusting layer; and
light transmittance of the light transmittance adjusting layer is configured to be adjusted at least partially according to a change in directions of the driving electric fields.

16. The method for driving the LCD device according to claim 15, wherein the first driving voltage and the second driving voltage are applied respectively to the first electrode and the second electrode in the adjacent display frames; and
signs of the first voltage differences between the first electrode and the second electrode in the adjacent display frames are opposite.

17. The method for driving the LCD device according to claim 16, wherein absolute values of the first voltage differences between the first electrode and the second electrode in the adjacent display frames are equal.

18. The method for driving the LCD device according to claim 16, wherein the LCD device further comprises a liquid crystal light adjusting structure;
the liquid crystal light adjusting structure comprises a liquid crystal layer, a pixel electrode and a common electrode;
the pixel electrode and the common electrode are respectively applied with a pixel data voltage and a common voltage to form a liquid crystal driving electric field for controlling rotation of liquid crystal molecules in the liquid crystal layer; and
the driving method further comprises:
respectively applying the pixel data voltage and the common voltage to the pixel electrode and the common electrode in the adjacent display frames, so as to allow directions of liquid crystal driving electric fields in the adjacent display frames to be opposite,
wherein allowing of the directions of the liquid crystal driving electric fields in the adjacent display frames to be opposite comprises: allowing signs of second voltage differences between the pixel electrode and the common electrode to be opposite; and
the first driving voltage and the second driving voltage are respectively used as the pixel data voltage and the common voltage.

19. The method for driving the LCD device according to claim 15, wherein the LCD device further comprises a liquid crystal light adjusting structure;
the liquid crystal light adjusting structure comprises a liquid crystal layer, a pixel electrode and a common electrode;
the pixel electrode and the common electrode are respectively applied with a pixel data voltage and a common voltage to form a liquid crystal driving electric field for controlling rotation of liquid crystal molecules in the liquid crystal layer; and
the driving method further comprises:
respectively applying the pixel data voltage and the common voltage to the pixel electrode and the common electrode in the adjacent display frames, so as to allow the directions of the liquid crystal driving electric fields in the adjacent display frames to be opposite.

20. The method for driving the LCD device according to claim 19, wherein the pixel data voltage and the common voltage are respectively applied to the pixel electrode and the common electrode in the adjacent display frames, so as to allow absolute values of second voltage differences between the pixel electrode and the common electrode to be equal, and allow signs of the second voltage differences to be opposite.
